(19) United States
(12) Patent Application Publication
(10) Pub. No.: US 2009/0002409 A1
(43) Pub. Date: Jan. 1, 2009

(54) Inkjet printer and method for correcting the printing thereof

(75) Inventor: Sheng-Hui Wu, Sanchong City (TW)

Correspondence Address: BACON & THOMAS, PLLC, 625 SLATERS LANE, FOURTH FLOOR, ALEXANDRIA, VA, 22314-1176, US

(73) Assignee: Qisda Corporation, Gueishan Hsiang (TW)

(21) Appl. No.: 12/213,891

(22) Filed: Jun. 26, 2008

(30) Foreign Application Priority Data
Jun. 27, 2007 (TW) 96123385

(51) Int. Cl. B41J 29/38

(52) U.S. Cl. 347/6

(57) ABSTRACT

A method for correcting the printing of an inkjet printer includes the steps stated below. A first boundary and a second boundary of a printing region for the inkjet printer are set. Then, a first ink offset at the first boundary and a second ink offset at the second boundary are obtained. Next, a maximum compensative time of the inkjet printer when printing is determined according to the difference between the first ink offset and the second ink offset and a printing speed of the inkjet printer. Then, a compensative time of the inkjet printer when printing at an arbitrary location of the printing region is determined according to the first boundary, the second boundary and the maximum compensative time.

This application claims the benefit of Taiwan application Serial No. 96123385, filed Jun. 27, 2007, the subject matter of which is incorporated herein by reference.

### BACKGROUND OF THE INVENTION

1. Field of the Invention

The invention relates in general to an inkjet printer, and more particularly to an inkjet printer and a method for correcting the printing thereof to reduce the distortion of images.

2. Description of the Related Art

When an inkjet printer is assembled completely, the carriage of the inkjet pen in the inkjet printer may be out of the range of its tolerance due to the human factor or the inaccuracy in size, resulting in the tilting alignment of the inkjet pen. Therefore, the moving path of the inkjet pen and a printing surface may not be parallel enough, thus affecting the printing effect and further degrading the printing quality.

FIG. 1A is a diagram showing the moving path of an inkjet pen not parallel to a printing surface. An inkjet printer 100 includes an inkjet pen 110 and a carriage 120. The carriage 120 is not parallel to the printing surface A such that the moving path MP of the inkjet pen 110 on the carriage 120 is affected, not keeping the pen-to-paper space (PTS) between the inkjet pen 110 and the printing surface A to be constant. For example, the location of the left end of the carriage 120 corresponding to the left boundary of the printing surface A has a maximum positive displacement y1, and the location of the right end of the carriage 120 corresponding to the right boundary of the printing surface A has a maximum negative displacement y2, so that the moving path MP of the inkjet pen 110 extends aslant relative to the printing surface A, thus a PTS error is generated.

Due to the PTS error, when the inkjet pen 110 moves at a constant speed, the required time of the ink from the inkjet pen 110 to the left boundary of the printing surface A is not the same as the required time of the ink from the inkjet pen 110 to the right boundary, resulting in the distortion of images. FIG. 1B shows the ink from the inkjet pen not at the correct location of the printing surface. In FIG. 1B, the locations where dotted arrows are represent the intended locations of the ink from the inkjet pen 110, and the locations where continuous arrows are represent the actual locations of the ink. In ideal situation that no PTS error occurs, distances PTS₁₁, PTS₂₂ and PTS₃₃ are equal. That is, the distance between the inkjet pen 110 and the printing surface A is constant as the inkjet pen 110 is at any location on the carriage 120 such as locations P₁₁, P₂₂ or P₃₃. And the required time Td of the ink from the inkjet pen 110 to the printing surface A should be constant, for example, time Td₁₁, Td₂₂ and Td₃₃ are the same. Moreover, the distance between the dotted arrow and the continuous arrow at any location of the printing surface A are also the same, for example, distances D₁₁=D₂₂=D₃₃. In the circumstances, the distortion of images can be prevented. However, when the carriage 120 has a PTS error, for example, distances PTS₁₁>PTS₂₂>PTS₃₃, then the required time Td₁₁>Td₂₂>Td₃₃, and distances D₁₁>D₂₂>D₃₃, such that the problem of image distortion happens, deteriorating the quality of printed images.

### SUMMARY OF THE INVENTION

It is therefore an object of the invention to provide an inkjet printer and a method for correcting the printing thereof. In the situation that a PTS error exists, the timing of the ink leaving the inkjet pen is controlled to adjust the location of the ink on the printing surface, largely improving the quality of printed images.

The invention achieves the above-identified object by providing a method for correcting the printing of an inkjet printer. The method includes the steps stated below. A first boundary and a second boundary of a printing region for the inkjet printer are set. Then, a first ink offset at the first boundary and a second ink offset at the second boundary are obtained. Next, a maximum compensative time of the inkjet printer when printing is determined according to the difference between the first ink offset and the second ink offset and a printing speed of the inkjet printer. Then, a compensative time of the inkjet printer when printing at an arbitrary location of the printing region is determined according to the first boundary, the second boundary and the maximum compensative time.

The invention achieves the above-identified object by providing an inkjet printer. The inkjet printer includes an inkjet pen, a sensing unit and a controlling unit. The inkjet pen is for printing at a first boundary, a second boundary and an arbitrary location between the first and second boundaries of a printing region. The sensing unit is for sensing ink location to transferring a signal accordingly. The controlling unit is electrically connected to the inkjet pen and the sensing unit. The controlling unit determines a first ink offset at the first boundary and a second ink offset at the second boundary by receiving the signal transferred from the sensing unit, the controlling unit then determines a maximum compensative time of the inkjet pen according to the difference between the first and second ink offsets and a printing speed of the inkjet pen, the controlling unit also determines a compensative time of the inkjet printer at an arbitrary location of the printing region according to the first boundary, the second boundary and the maximum compensative time.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A is a diagram showing the moving path of an inkjet pen not parallel to a printing surface;

FIG. 1B shows the ink from the inkjet pen not at the correct location of the printing surface;

FIG. 2 is a flowchart showing the steps of the method for correcting the printing of an inkjet printer according to a preferred embodiment of the invention;

FIG. 3 is a diagram illustrating the step of measuring the ink offsets on the boundaries;

FIG. 4 is a diagram illustrating the step of measuring the ink offsets by double alignment printing;

FIG. 5 shows the inkjet pen at the second boundary both before and after the time compensation;

FIG. 6 is a diagram illustrating a dynamic adjustment of the compensative time; and

FIG. 7 is a block diagram of the inkjet printer according to the preferred embodiment of the invention.

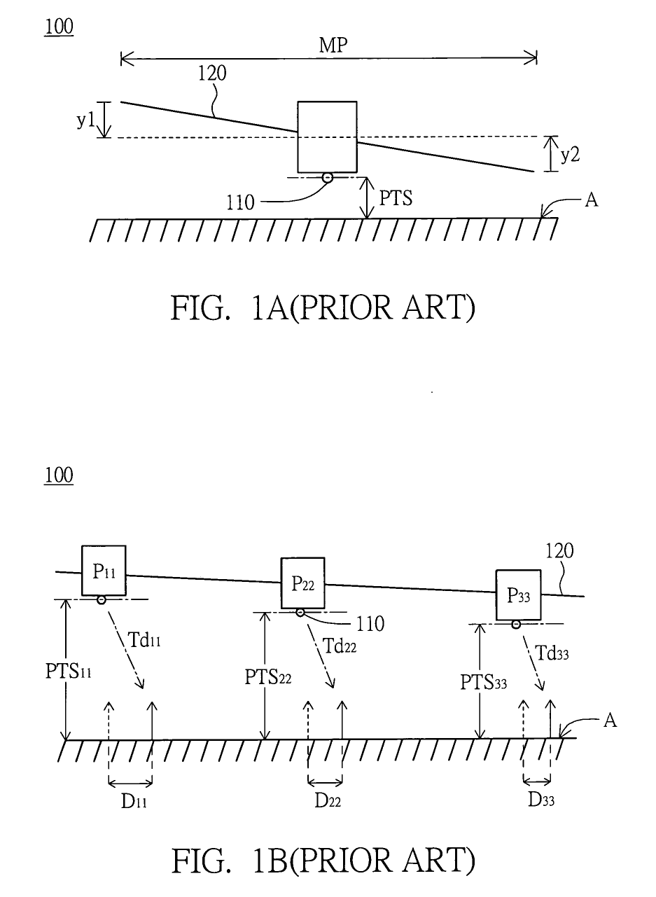

### DETAILED DESCRIPTION OF THE INVENTION

The method for correcting the printing of an inkjet printer can be used in conventional inkjet printers that have PTS errors, so as to improve the quality of printed images.

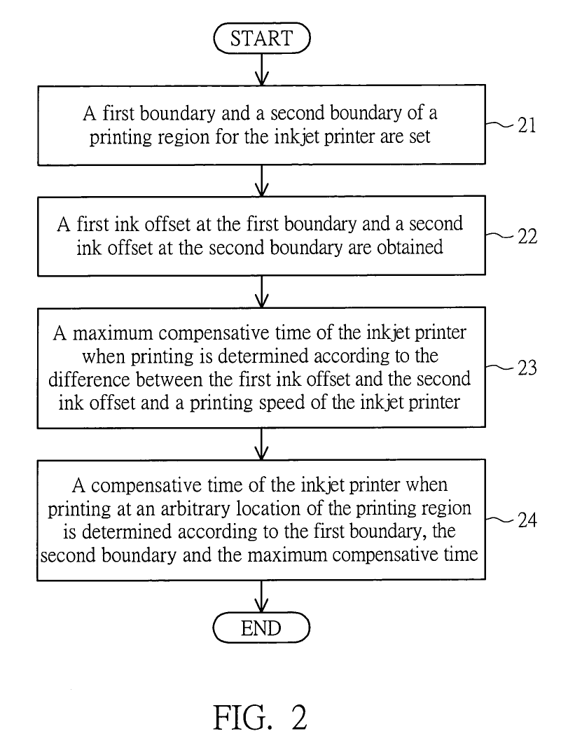

FIG. 2 is a flowchart showing the steps of the method for correcting the printing of an inkjet printer according to a preferred embodiment of the invention. The method includes steps 21 to 24. In step 21, a first boundary and a second boundary of a printing region for the inkjet printer are set. Then in step 22, a first ink offset at the first boundary and a second ink offset at the second boundary are obtained. Next, in step 23, a maximum compensative time of the inkjet printer when printing is determined according to the difference between the first ink offset and the second ink offset and a printing speed of the inkjet printer. Then in step 24, a compensative time of the inkjet printer when printing at an arbitrary location of the printing region is determined according to the first boundary, the second boundary and the maximum compensative time.

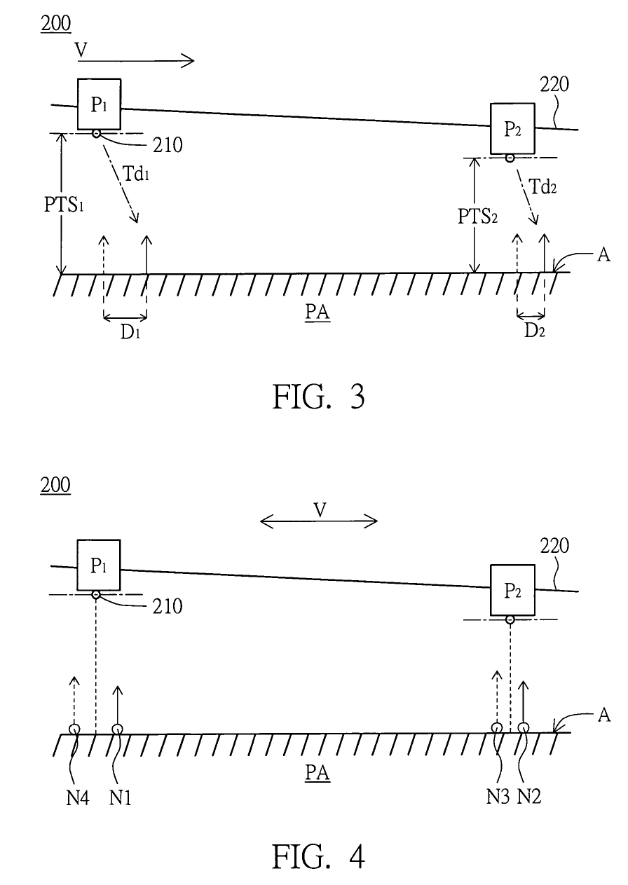

Due to the limitation of the parts in the inkjet printer such as a carriage and other mechanisms, the inkjet pen of the inkjet printer is restricted to move and to print within a printing region. In step 21, two boundaries of the printing region for the inkjet pen are defined. FIG. 3 is a diagram illustrating the step of measuring the ink offsets at the boundaries. In FIG. 3, the locations where dotted arrows are represent the intended locations of the ink from the inkjet pen, and the locations where continuous arrows are represent the actual locations of the ink. The inkjet pen 210 of the inkjet printer 200 moves at a constant speed V between a first boundary P₁ and a second boundary P₂ of the printing region PA. The first and second boundaries P₁ and P₂ are, for example, a left and right boundaries of the printing region PA, respectively. The relationship between the PTS at the first and second boundaries P₁ and P₂ is, for example, PTS₁>PTS₂, so that the required time Td₁ of the ink from the inkjet pen 210 to the first boundary P₁ of the printing region PA is greater than time Td₂. Accordingly, the first ink offset D₁ at the first boundary P₁ is greater than the second ink offset D₂ at the second boundary P₂.

In step 22, the first and second ink offsets D₁ and D₂ at the first and second boundaries P₁ and P₂, respectively, are acquired by means of, for example, a double alignment printing method. FIG. 4 is a diagram illustrating the step of measuring the ink offsets by double alignment printing. The inkjet pen 210 first prints a first mark N1 and a second mark N2 at the first and second boundaries P1 and P2, respectively, when moving from P₁ to P₂, and then prints a third mark N3 and a fourth mark N4 at the second and first boundaries P₂ and P₁, respectively, when moving from P₂ to P₁.

The first ink offset D₁ at the first boundary P₁ is then calculated according to the first and fourth marks N1 and N4. Besides, the second ink offset D₂ at the second boundary P₂ is calculated from the second mark N2 and the third mark N3. Since the inkjet pen 210 prints on the printing region PA once when moving from P₁ to P₂, as well as moving from P₂ to P₁, so that the first ink offset D₁ is substantially half the distance between the first mark N1 and the fourth mark N4, and the second ink offset D₂ is substantially half the distance between the second mark N2 and the third mark N3. Further the difference ΔD between the first ink offset D₁ and the second ink offset D₂ is known, which is calculated from the expression D₁-D₂.

In step 23, the maximum compensative time of the inkjet printer is determined according to the difference between the first ink offset D₁ and the second ink offset D₂ and the printing speed of the inkjet pen 210. In the present embodiment, since the inkjet pen 210 starts from the first boundary P₁ where the inkjet pen 210 has the maximum distance PTS₁ (shown in FIG. 3), there is no need to make compensation of time as the inkjet pen 210 is at the location of the carriage 220 corresponding to the first boundary P₁. That is, the compensative time ΔT₁=0. However, the inkjet pen 210 needs a maximum compensative time ΔT₂ at the second boundary P₂ for generating a second ink offset D₂′ equal to the first ink offset D₁. The inkjet pen 210 moves at the constant speed V, the maximum compensative time ΔT₂ on the second boundary P₂ is therefore calculated from the expression ΔD/V.

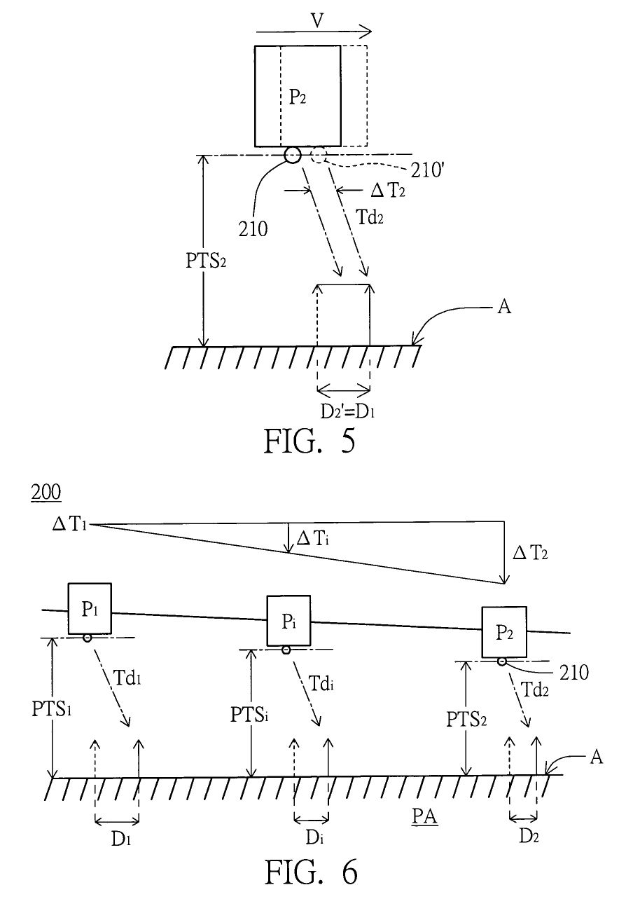

FIG. 5 shows the inkjet pen at the second boundary both before and after the time compensation. When the inkjet pen 210 moves to the second boundary P₂, due to the compensative time ΔT₂, the inkjet pen 210 does not release the ink at time Td₂ but time Td₂′, which is Td₂+ΔT₂. Meanwhile, the inkjet pen 210 has moved to the location where the inkjet pen 210′ is. The second ink offset D₂′ is therefore equal to the first ink offset D₁.

In step 24, since the maximum compensative time ΔT₂ is known, the compensative time ΔTᵢ of the inkjet pen 210 at any location of the printing region PA can be determined from the first and second boundaries P₁ and P₂ and the maximum compensative time ΔT₂.

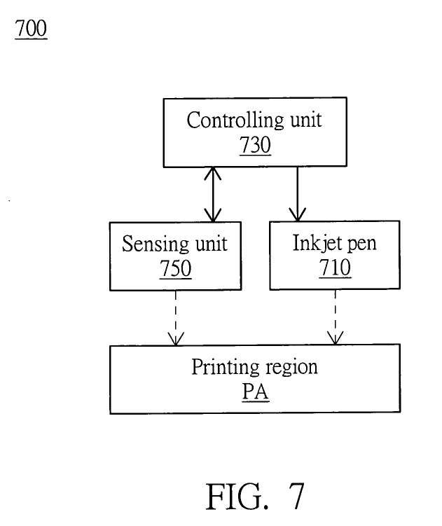

FIG. 6 is a diagram illustrating a dynamic adjustment of the compensative time. The inkjet pen 210 at the first boundary P₁ is at the maximum distance PTS₁ from the printing region PA and needs no time compensation, the compensative time ΔT₁=0. The inkjet pen 210 at the second boundary P₂ is at the minimum distance PTS₂ from the printing region PA, thus needs time compensation, that is the compensative time ΔT₂, which is equal to ΔD/V. Other compensative time ΔTᵢ of the inkjet pen 210 at an arbitrary location between the boundaries P₁ and P₂ of the printing region PA can be calculated from the relationship between the location of the inkjet pen 210 and the first and second boundaries P₁ and P₂.

The first ink offset D₁ is greater than the second ink offset D₂ in the present embodiment. According to the relationship between the location of the inkjet pen 210 and the first and second boundaries P₁ and P₂, the compensative time ΔTᵢ=(ΔLA/ΔL)×ΔT₂, wherein ΔL is the distance between the first boundary P₁ and the second boundary P₂, and ΔLA is the distance between the arbitrary location Pᵢ and the first boundary P₁. As the compensative time ΔTᵢ of the inkjet pen 210 at the location Pᵢ is known, the inkjet pen 210 releases the ink at time Tᵢ+ΔTᵢ to let the ink offset Dᵢ equal to the ink offset D₁. Since the ink offsets of the inkjet pen 210 at any locations of the printing region PA are all the same, the distortion problem of images is solved accordingly, and further improving the printing quality.

FIG. 7 is a block diagram of the inkjet printer according to the preferred embodiment of the invention. The inkjet printer 700 is capable of performing the function of correcting its printing as the method mentioned above. The inkjet printer 700 includes an inkjet pen 710, a controlling unit 730 and a sensing unit 750. The controlling unit 730 is electrically connected to the inkjet pen 710 and the sensing unit 750. The inkjet pen 710 is for printing on a printing region PA. The sensing unit 750 is for sensing ink location to transfer a signal accordingly. Then the controlling unit 730 receives the signal to adjust the location of the inkjet pen 730. The sensing unit 750 is, for example, a photo sensor. The photo sensor projects a light beam onto the printing region PA, and then receives the reflected light beam to generate electrical signals and transfer the signals to the controlling unit 730.

The controlling unit 730 actuates the inkjet pen 710 to move at a constant speed V and to print a first, second, third and fourth marks N1 to N4 (shown in FIG. 4) at the first and second boundaries P₁ and P₂ of the printing region PA. The sensing unit 750 then senses the locations of the marks N1 to N4 and transfers the signals to the controlling unit 730. According to the signals transferred from the sensing unit 750, the controlling unit 730 determines a first ink offset D₁ at the first boundary P₁ and a second ink offset D₂ at the second boundary P₂, so as to calculate the difference ΔD between the first and second ink offsets D₁ and D₂. According to the difference ΔD and the speed V, the controlling unit 730 further determines a maximum compensative time ΔT₂ of the inkjet pen 710 at the second boundary P₂. The compensative time ΔTᵢ of the inkjet pen 710 at an arbitrary location Pᵢ of the printing region PA is calculated based on the first and second boundaries P₁ and P₂, the maximum compensative time ΔT₂ and the relationship between the location of the inkjet pen 710 and the first or second boundary P₁ or P₂. The controlling unit 730 then adjusts the printing time of the inkjet pen 710 with the calculated compensative time.

The inkjet printer and the method for correcting the printing of the inkjet printer in the embodiment are applicable to electronic devices, such as photostats, multi function peripherals etc., that are used for printing images, so as to eliminate the distortion of images due to PTS error. Instead of manually correcting the PTS error caused by the carriage, the inkjet pen, or other parts after the assembly of the inkjet printer, the inkjet printer has the ability to automatically adjust its printing time according to the compensative time generated from the method for correcting the printing. Therefore, the printed images from the inkjet printer can still have good quality without any manual adjustment to the inkjet printer.

The inkjet printer and the method for correcting the printing of the inkjet printer according to the preferred embodiment of the invention first determine the maximum compensative time of the inkjet pen on the printing region. The compensative time of the inkjet pen at any other location is then calculated according to the maximum compensative time to advance or to delay the printing time of the inkjet pen, rendering the ink offsets at any locations of the printing region the same. Therefore, the PTS error does not need to be manually corrected after assembly but the printing accuracy of images is improved.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for correcting the printing of an inkjet printer, comprising:
(a) setting a first boundary and a second boundary of a printing region;
(b) obtaining a first ink offset at the first boundary and a second ink offset at the second boundary;
(c) determining a maximum compensative time according to the difference between the first ink offset and the second ink offset and a printing speed of the inkjet printer; and
(d) determining a compensative time of the inkjet printer when printing at an arbitrary location of the printing region according to the first boundary, the second boundary and the maximum compensative time.

2. The method according to claim 1, wherein the step (b) comprises:
(b1) moving an inkjet pen of the inkjet printer from the first boundary to the second boundary to print a first mark at the first boundary and a second mark at the second boundary;
(b2) moving the inkjet pen from the second boundary to the first boundary to print a third mark at the second boundary and a fourth mark at the first boundary; and
(b3) obtaining the first ink offset by measuring the distance between the first mark and the fourth mark, and obtaining the second ink offset by measuring the distance between the second mark and the third mark.

3. The method according to claim 2, wherein the first ink offset is substantially half the distance between the first mark and the fourth mark, and the second ink offset is substantially half the distance between the second mark and the third mark.

4. The method according to claim 3, wherein in step (c) the maximum compensative time ΔT=ΔD/V, ΔD is the difference between the first ink offset and the second ink offset, and V is the printing speed of the inkjet printer.

5. The method according to claim 4, wherein as the first ink offset is greater than the second ink offset, the compensative time at the arbitrary location of the printing region ΔTi=(ΔLA/ΔL)×ΔT, ΔL is the distance between the first boundary and the second boundary, and ΔLA is the distance between the arbitrary location and the first boundary.

6. An inkjet printer, comprising:
an inkjet pen for printing at a first boundary, a second boundary and an arbitrary location between the first and second boundaries of a printing region;
a sensing unit for sensing ink location to transfer a signal accordingly; and
a controlling unit electrically connected to the inkjet pen and the sensing unit, wherein the controlling unit determines a first ink offset at the first boundary and a second ink offset at the second boundary by receiving the signal transferred from the sensing unit, the controlling unit then determines a maximum compensative time of the inkjet pen according to the difference between the first and second ink offsets and a printing speed of the inkjet pen, the controlling unit also determines a compensative time of the inkjet printer at an arbitrary location of the printing region according to the first boundary, the second boundary and the maximum compensative time.

7. The inkjet printer according to claim 6, wherein the controlling unit actuates the inkjet pen to move from the first boundary to the second boundary to print a first mark at the first boundary and a second mark at the second boundary, the controlling unit then actuates the inkjet pen to move from the second boundary to the first boundary to print a third mark at the second boundary and a fourth mark at the first boundary, the controlling unit determines the first ink offset by measuring the distance between the first mark and the fourth mark, and determines the second ink offset by measuring the distance between the second mark and the third mark.

8. The inkjet printer according to claim 7, wherein the first ink offset is substantially half the distance between the first mark and the fourth mark, and the second ink offset is substantially half the distance between the second mark and the third mark.

9. The inkjet printer according to claim 8, wherein the maximum compensative time ΔT=ΔD/V, ΔD is the difference between the first ink offset and the second ink offset, and V is the printing speed of the inkjet printer.

10. The inkjet printer according to claim 9, wherein as the first ink offset is greater than the second ink offset, the compensative time at the arbitrary location of the printing region ΔTi=(ΔLA/ΔL)×ΔT, ΔL is the distance between the first boundary and the second boundary, and ΔLA is the distance between the arbitrary location and the first boundary.
